(19) United States
(12) Patent Application Publication
(10) Pub. No.: US 2011/0258252 A1
(43) Pub. Date: Oct. 20, 2011

(54) Personal task planning with automatic task discovery

(76) Inventors: Javier Maria Torres Ramon, Madrid (ES); Luis Osa Gomez Del Campo, Madrid (ES); Manuel Couceiro Dominguez, Madrid (ES); David Suarez Fuentes, Madrid (ES)

(21) Appl. No.: 13/126,529

(22) PCT Filed: Oct. 29, 2008
(86) PCT No.: PCT/IB2008/002896

§ 371 Date: Jul. 7, 2011

(51) Int. Cl. G06F 15/16

(52) U.S. Cl. 709/203

(57) ABSTRACT

A server which manages the activities of a user includes a region discovery module that receives location data over time of the user and determines an area of the user any given time from the location data. The server includes a task and location modeling module which determines whether a task for the user is currently linked with the area; and where a task is linked with the user, the task and location modeling module submits task information to the user; and where no task is linked with the area, the task and location modeling module inquires the user whether a new task is desired to be linked with the area. A method for managing the activities of a user. An apparatus that accompanies a user. A method for assisting the activities of a user.

### TECHNICAL FIELD

The present invention is related to personal task planning with automatic task discovery. (As used herein, references to the “present invention” or “invention” relate to exemplary embodiments and not necessarily to every embodiment encompassed by the appended claims.) More specifically, the present invention is related to personal task planning with automatic task discovery that uses location data, time and speed of the user to determine whether the user is ready to receive one of the user's tasks suitable for that area.

### BACKGROUND

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Automated planning ([Ghallab et al, 2004] Ghallab, Malik; Nau, Dana S. & Traverso, Paolo (2004), Automated Planning: Theory and Practice, Morgan Kaufmann, ISBN 1-55860-856-7) is a branch of artificial intelligence that concerns the realization of strategies or action sequences (a plan). In some applications the model of the world needs to be acquired and evaluated dynamically. The strategies used will depend on this gathered information.

A Personal Information Manager (Jones, W. (2006). Personal information management. The Annual Review of Information Science and Technology, 41) is a device that manages the activities people perform in order to acquire, organize, maintain, retrieve and use information items for everyday use to complete tasks and fulfill a person's needs.

A personal task planner applies automated planning techniques to manage a user's everyday activities. See FIG. 1.

A task is defined as some activity a person carries out in a specific location, as opposed to moving across a large geographical area.

Automated planning has been thoroughly studied in the context of personnel scheduling. In this context the main axes are People, Time and Duty, and the constraints can be checked in a fixed central planning repository. Also, the constraints include the needs of the organization carrying out the planned activity (represented by the Duties), as well as perfect knowledge about all the workers (represented by the People).

This type of technology has also been applied to logistics, where a number of resources (trucks, planes) must perform a series of trips in order to deliver items in an optimized time interval. Logistic companies, but also transport companies such as airlines, can benefit from algorithms such as GRAPHPLAN (see A. Blum and M. Furst, “Fast Planning Through Planning Graph Analysis”, Artificial Intelligence, 90:281-300 (1997)).

Personal information managers have also been proposed during the last decade to help a human navigate through a complex process. A previous experience on planning and negotiation can be found in CMRadar (see “CMRADAR: A Personal Assistant Agent for Calendar Management”, Pragnesh Jay Modi, Manuela Veloso, Stephen F. Smith, Jean Oh, Agent Oriented Information Systems, (AOIS) 2004). This work focuses on negotiating agendas among several actors using agents to achieve a solution to a set of global constraints exchanging a subset of the available information. Other examples of personal agents include CALO (Conflict Negotiation Among Personal Calendar Agents. Pauline M. Berry, Cory Albright, Emma Bowring, Ken Conley, Kenneth Nitz, Jonathan P. Pearce, Bart Peintner, Shahin Saadati, Milind Tambe, Tomás Uribe, and Neil Yorke-Smith. Proceedings AAMAS'06, May 8-12, 2006, Hakodate, Hokkaido, Japan), whose features relevant to the case here have been extracted:
Organize & Manage Information
Observe & Mediate Interactions
Monitor & Manage Tasks
Schedule & Organize in Time
Acquire & Allocate Resources

One existing patent (see “Automatic Planning and Cueing System and Method”, U.S. Pat. No. 7,027,996, incorporated by reference herein) even describes a planning system to organize the daily tasks for a person. This system is aimed at people with cognitive impairment, and also provides cueing methods to convey the task information.

Current geolocation systems, currently use statistical methods to find fastest routes according to context (most frequently time), by aggregating the location data of thousands of users in their servers.

Existing solutions focusing on personnel scheduling often require the full definition of planning constraints before a plan can be produced.

Existing automatic planning solutions that can handle location constraints use very specific locations (e.g. rooms, buildings, etc) often defined in advance using a set of coordinates.

Existing solutions for personal scheduling also require input from the user for every possible choice. This preparation steps usually discourage the user from using such systems, because s/he spends more time “feeding” the system than benefiting from it.

Existing geolocation systems provide just aggregate information about route duration. However, they do not keep per-user preferences nor combine route duration with other kinds of information (e.g. organizing tasks and trips in a single schedule) in any way for a specific user.

### SUMMARY

The present invention pertains to a server which manages the activities of a user. The server comprises a region discovery module that receives location data over time of the user and determines an area of the user any given time from the location data. The server comprises a task and location modeling module which determines whether a task for the user is currently linked with the area; and where a task is linked with the area, the task and location modeling module submits task information to the user; and where no task is linked with the area, the task and location modeling module inquires the user whether a new task is desired to be linked with the area.

The present invention pertains to a method for managing the activities of a user. The method comprises the steps of receiving location data over time of the user at a region discovery module. There is the step of determining an area of the user at any given time from the location data with the region discovery module 12. There is the step of submitting task information to the user with a task and location modeling module 14 where a task is linked with the user, and inquiring the user with the task and location modeling module 14 whether a new task is desired to be linked with the area where no task is linked with the area.

The present invention pertains to an apparatus that accompanies a user. The apparatus comprises a locator for obtaining the user's location over time. The apparatus comprises a transmitter for transmitting the locations of the user over time to a server. The apparatus comprises a control unit for controlling state and communication with the server. The apparatus comprises a pop-up interface for inquiring the user about tasks the user is currently doing. The apparatus comprises a query interface for allowing the user to specify a set of tasks that need to be finished in a certain time. In particular, the user's location over time may be obtained, amongst others, from a cellular system where the user is attached, from the user's cellular terminal, or via GPS or assisted GPS.

The present invention pertains to a method for assisting the activities of a user. The method comprises the steps of obtaining the user's location over time with a locator of an apparatus that accompanies the user. There is the step of transmitting the locations of the user over time to a server with a transmitter of the apparatus. There is the step of controlling state and communication with the server with a control unit of the apparatus. There is the step of inquiring the user about tasks the user is currently doing with a pop-up interface of the apparatus. There is the step of specifying a set of tasks by the user to a query interface of the apparatus that need to be finished in a certain time. Aligned with the above apparatus and also particularly in this method, the user's location over time may be obtained, amongst others, from a cellular system where the user is attached, from the user's cellular terminal, or via GPS or assisted GPS.

The present invention pertains to a method for managing the activities of a user. The method comprises the steps of receiving location data over time of the user at a region discovery module. There is the step of determining an area of the user at any given time from the location data with the region discovery module. There is the step of submitting task information to the user with a task and location modeling module where a task is linked with the user, and inquiring the user with the task and location modeling module whether a new task is desired to be linked with the area where no task is linked with the area.

### BRIEF DESCRIPTION OF THE DRAWINGS

In the accompanying drawings, the preferred embodiment of the invention and preferred methods of practicing the invention are illustrated in which:

FIG. 1 is a diagram showing personal task planning is the intersection of automatic planning and personal information management.

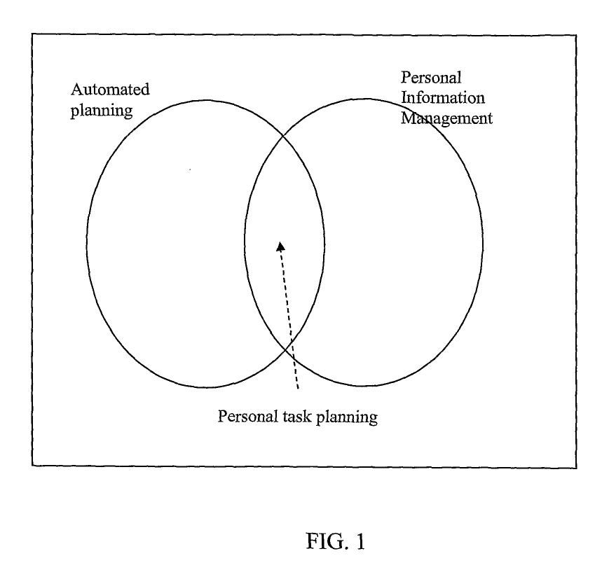

FIG. 2 shows an example of a user at a location defined as a supermarket.

FIG. 3 shows task planning according to user preferences.

FIG. 4 is a representation of the client application and server application of the present invention.

FIG. 5 shows a flow chart regarding the present invention.

FIG. 6 shows task definition as an enabler for planning service provider.

### DETAILED DESCRIPTION

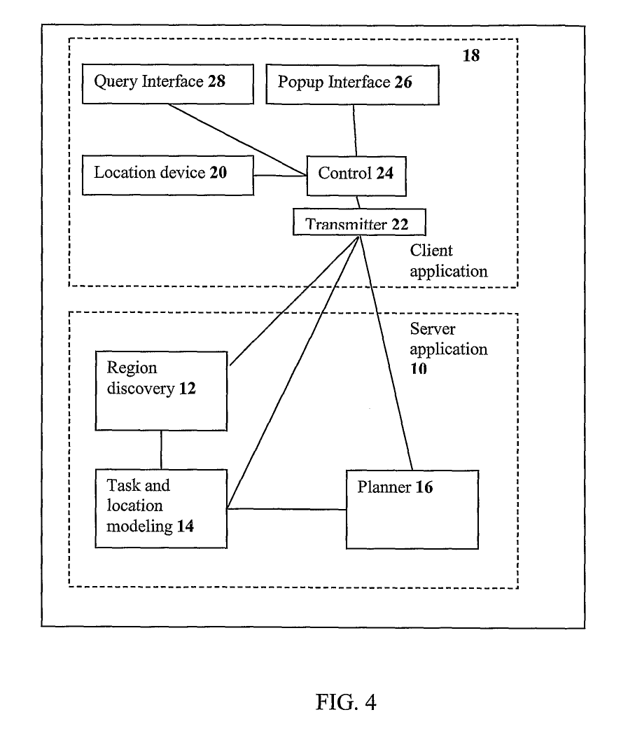

Referring now to the drawings wherein like reference numerals refer to similar or identical parts throughout the several views, and more specifically to FIG. 4 thereof, there is shown a server 10 which manages the activities of a user. The server 10 comprises a region discovery module 12 that receives location data over time of the user and determines an area of the user any given time from the location data. The server 10 comprises a task and location modeling module 14 which determines whether a task for the user is currently linked with the area; and where a task is linked with the area, the task and location modeling module 14 submits task information to the user; and where no task is linked with the area, the task and location modeling module 14 inquires the user whether a new task is desired to be linked with the area.

The region discovery module 12 and the task and location modeling module 14 can cooperate to determine from the location data, time and speed of the user whether the user is ready to receive one of the user's tasks suitable for that area. The task and location modeling module 14 can receive a new task to be linked with the area as a response to a submission by the user to the task and location modeling module 14 or inquiry by the task and location modeling module 14.

The region discovery module 12 can use the location data over time to monitor speed of the user, and determines from recorded user's locations the area where the user has a speed below a speed threshold. The task and location modeling module 14 can calculate a rating for each task linked with an area. When the task and location modeling module 14 cannot link the task with the area, or a rating for the area is lower than a predefined threshold value, the task location modeling module can inquire the user about a possible current task. The server 10 can include a planner 16 for receiving task requirements and planning tasks.

The apparatus that accompanies the user which carries out the client application as described herein can be for instance a mobile communication device such as a cell phone. The apparatus should have a processor, a memory to store data and programs, a display, and input pad to enter data, a microphone to enter data, a transmitter to transmit data, and a receiver to receive data.

The server can be a typical computer that has a processor, memory to store data and programs, such as the region discovery module and the task and location modeling module, a transmitter to transmit data, a receiver to receive data, and likely a display and an input interface to enter data.

The present invention pertains to a method for managing the activities of a user. The method comprises the steps of receiving location data over time of the user at a region discovery module. There is the step of determining an area of the user at any given time from the location data with the region discovery module 12. There is the step of submitting task information to the user with a task and location modeling module 14 where a task is linked with the area, and inquiring the user with the task and location modeling module 14 whether a new task is desired to be linked with the area where no task is linked with the area.

The determining step can include the step of the region discovery module 12 and the task and location module 14 cooperating to determine from the location data, time and speed of the user whether the user is ready to receive one of the user's tasks suitable for that area. The determining step can include the step of the task and location modeling module 14 receiving a new task to be linked with the area as a response to a submission by the user to the task and location modeling module 14 or inquiry by the task and location modeling module 14.

The determining step can include the steps of the region discovery module 12 using the location data over time to monitor speed of the user, and determining from recorded user's locations the area where the user has a speed below a speed threshold. There can be the step of receiving task requirements and planning tasks with a planner 16.

The present invention pertains to an apparatus 18 that accompanies a user. The apparatus 18 comprises a locator 20 for obtaining the user's location over time. The apparatus 18 comprises a transmitter 22 for transmitting the locations of the user over time to a server 10. The apparatus 18 comprises a control unit 24 for controlling state and communication with the server 10. The apparatus 18 comprises a pop-up interface 26 for inquiring the user about tasks the user is currently doing. The apparatus 18 comprises a query interface 28 for allowing the user to specify a set of tasks that need to be finished in a certain time. In particular, the user's location over time may be obtained, amongst others, from a cellular system where the user is attached, from the user's cellular terminal, or via GPS or assisted GPS.

The present invention pertains to a method for assisting the activities of a user. The method comprises the steps of obtaining the user's location over time with a locator 20 of an apparatus 18 that accompanies the user. There is the step of transmitting the locations of the user over time to a server 10 with a transmitter 22 of the apparatus 18. There is the step of controlling state and communication with the server 10 with a control unit 24 of the apparatus 18. There is the step of inquiring the user about tasks the user is currently doing with a pop-up interface 26 of the apparatus 18. There is the step of specifying a set of tasks by the user to a query interface 28 of the apparatus 18 that need to be finished in a certain time. In particular, the user's location over time may be obtained, amongst others, from a cellular system where the user is attached, from the user's cellular terminal, or via GPS or assisted GPS.

The present invention pertains to a method for assisting the activities of a user. The method comprises the steps of sending from a user's apparatus 18 that accompanies the user, at defined intervals, the user's location towards a task and location modeling module 14 there is the step of recording successive user's locations at the task and location modeling module 14. There is the step of monitoring the speed of the user to detect an area where the user carries out a task. There is the step of determining from recorded user's locations at the task and location modeling module 14 the area where the speed is below a predetermined speed and linking the task to the area and time.

In the operation of the invention, an important feature is to feed an automatic planning system with requirements about the tasks and traveling times for a specific user from information inferred from this user's behavior, such as patterns in the user's trips.

The invention comprises an apparatus 18, such as a Client Application, and a Server 10 Application.

A task location is defined as the location where a task is performed. The Server Application will use quick changes in location followed by slow changes in location to infer when a user is performing a task as opposed to moving between locations. When a user is detected to start a task (i.e. move slowly after having moved quickly) asking about the current task is triggered.

The Client Application will then ask the user what task he is currently engaged in if it is not possible to produce a guess with a threshold certainty level. According to context, the Client Application can suggest the name of previously entered tasks. Context includes the user's location, at various resolution levels (city, street, office, home, etc . . . ), the current time, among others.

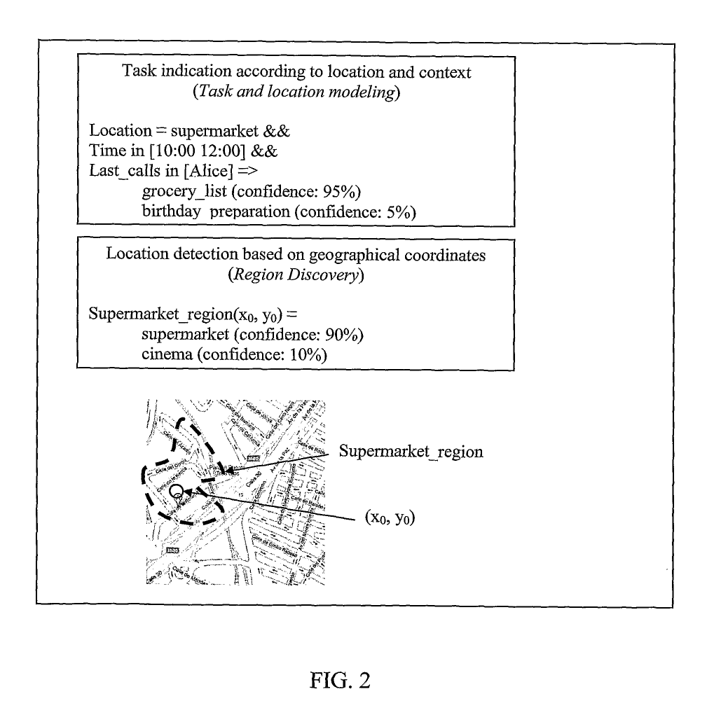

For example, and referring to FIG. 2, a user is at the location defined as supermarket. The Server application indicates to the Client Application to suggest the grocery list, because the supermarket is defined as a task location and the user has entered “grocery list” as a task previously in the same broad location. Switching tasks happens when the user is exiting the supermarket and the Client Application asks the user if the task is to be confirmed as done.

The server 10 retains all information about tasks, locations and time switching tasks (it tracks traveling time as the time elapsed between tasks, as defined above) and builds a model of the time taken by each task. Traveling time between task points can be obtained right now from different sources (e.g. GPS or assisted GPS tools or applications). When task location overlaps with several tasks, e.g. at home, other criteria such as time of the day and tasks already done can be used to select which task list to present to the user.

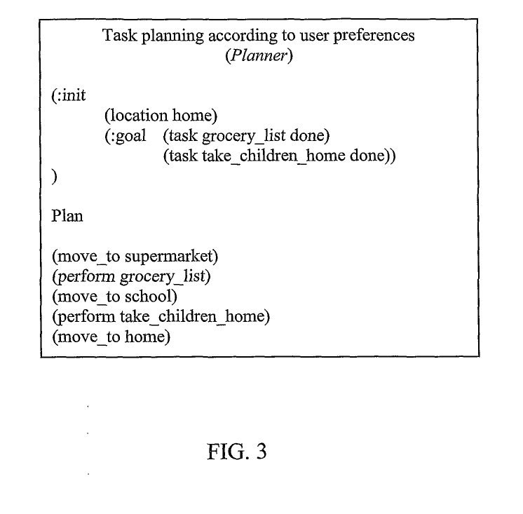

At any point, the user can request a plan for performing a list of tasks with (absolute or relative) deadlines. The server 10 will then take the user's model as input and provide a plan that can fulfill the user's deadlines with highest probability and minimal travelling time, or any other optimization criteria requested by the user. See FIG. 3.

The state of the task can be provided automatically from network data if it is defined by the operator (e.g. current location, number of messages sent, etc . . . ), with no action required from the end user.

Referring to FIG. 4, the invention consists of a Client 18 Application and a Server 10 Application.

The Client Application is deployed on a portable device or set of communicating devices, and it includes the following components:
Location device 20: obtains the user's location via cellular system, or GPS or Assisted GPS (thus enabling positioning inside buildings), or the like.
Control 24: keeps all necessary state and communication with the Server 10. May keep the status of unfinished tasks to warn its user.
Popup interface 26: asks the user about tasks he is currently doing, if necessary.
Query interface 28: allows the user to specify a set of tasks that need to be finished in a certain time.

The Server 10 Application is deployed on a data center across a network (possibly the operator's), and it includes the following components:
Region discovery 12: applies an algorithm (e.g. kernel SVMs) on a set of points on a map to obtain a surface that defines the given set. This surface has a name defined by the user, and defines a broad region, as opposed to a precise geographical location.
Task and location modeling 14: extracts requirements for tasks using the context, including region (as defined above), time and other tasks carried out in the user's history. These requirements are inferred from the user's past behavior. Requirements can usually be obtained in a rule tree form from these examples using exemplary algorithms as C4.5.
Planner 16: uses the requirements obtained to plan for queried actions. The current context can also match the requirements for non queried tasks, so these tasks are planned and presented to the user.

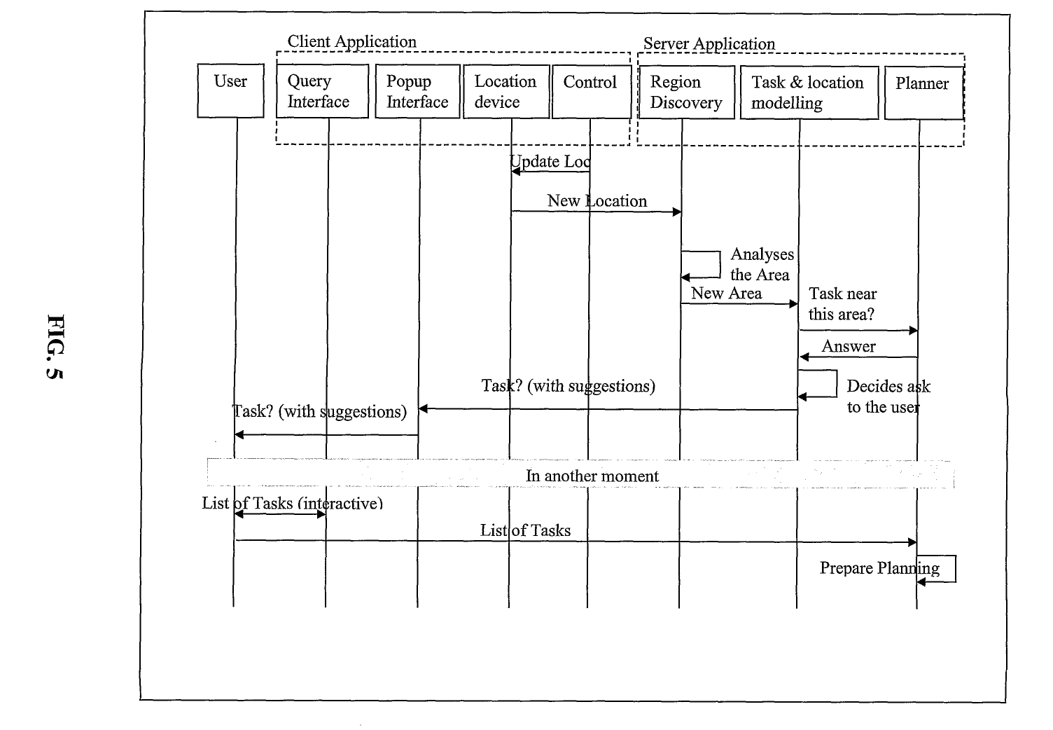

Referring to FIG. 5, the invention works in two steps, gathering information from the user and then planning activities for him.

1. The gathering step may include the following substeps.
a. The user's Mobile Equipment continuously (e.g. every minute) sends the user's location to a Task and location modeling module 14 in a remote location.
b. The Region discovery module 12 monitors the speed of the user to detect an area where the user carries out a task, e.g. by detecting a time frame in which the user moves fast followed by a time frame where the user spends some time in a restricted place.
c. The Region discovery module 12 extracts an “area” from the recorded locations where the speed was slow enough by using machine learning techniques (e.g. Kernel SVMs).
d. When a new location is detected, the Task and location modeling module 14 looks up the current task from the location (if possible).
e. If the current task cannot be found, or some confidence rating (e.g. the number of times this specific area was labeled) is low, the Task and location modeling module 14 asks the user whatever he is doing at the moment, prompting first other answers the user may have given at other times.

2. The planning step may include the following substeps.
a. The user selects a set of tasks to be performed during a time frame (a day, a week, etc), or a manually set timer detects that some tasks are due in the following time frame.
b. The Planner 16 module takes the current information about task duration/location and trip duration, and prepares a plan for the current time frame.

As a further enhancement, during step 2b above the Planner 16 can gather available data from other nodes in a telecommunication network and use them in the planned tasks.

These tasks shall contain at least an object identifier, e.g. an International Mobile Subscriber Identity ‘IMSI’ identifying a subscriber of a cellular system, to which the task applies, a timestamp and a state of the object, as defined by the task planning service, or as defined by the network operator, e.g. the current location of the object.

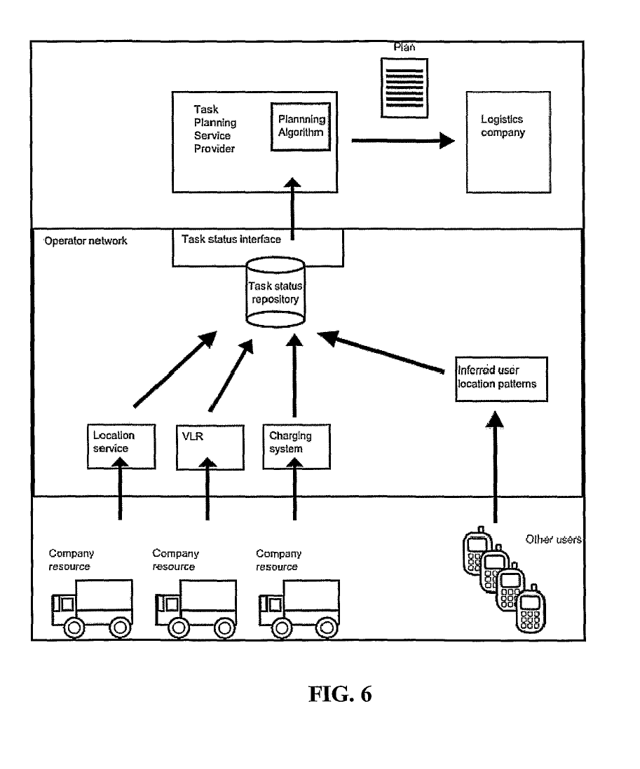

As shown in FIG. 6, the status of the task can be provided from network data if it is operator-defined (e.g. current location, number of messages sent, etc . . . ) or from terminal-installed client applications if it needs to be tailored to the service provider's needs (e.g. state of a commercial transaction). This is the case for the current application, which gathers location data from the cellular terminal itself.

FIG. 6 shows an example on how the planning techniques and systems help to optimize the resources usage. In this case there is a logistics company which has a number of resources (trucks, fuel, routes, goods, etc.) to be optimized. Every company's truck driver would have a mobile phone while she/he is at work. Through its network, the operator is able to track those mobiles receiving data coming from different sources (Visitor Locator Register, Operator's intra-cell location system, charging system, etc.). This data can be real data or inferred data extracted by using machine learning techniques (extracting patterns from user behavior). The operator might process this data to create a relation (place, time and task performed). These tasks will be stored into the Task status repository and in turn offered to the logistics company through a variety of interfaces. The logistics company might use this tasks information to generate the plan for every resource (track, agent, etc.). This plan will be sent to the mobiles for the drivers to follow it.

The invention allows the end user of a location device with mobile internet connectivity to track the completion of his/her activities and receive an optimal plan, extracting the information about said activities using both implicit and non-intrusive explicit methods, and recording them to a network server 10 where it can be readily available regardless of the specific device used.

The system provides the user with the most suitable information at every location. This context-awareness allows the network-based planner 16 to avoid bothering the user and at the same time help him/her when and where that information is relevant.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1.-15. (canceled)

16. A server which manages the activities of a user comprising;
a region discovery module that receives location data over time of the user to monitor speed of the user, and determines an area of the user at any given time from the location data by determining the area from recorded locations where the user has a speed below a speed threshold; and
a task and location modeling module which determines whether a task for the user is currently linked with the area; and where a task is linked with the area, a planner module takes the current information about the task and prepares a plan for the current time frame, and the task and location modeling module submits task information to the user for the current time frame; and where no task is linked with the area, the task and location modeling module inquires the user whether a new task is desired to be linked with the area.

17. The server as described in claim 16, wherein the region discovery module and the task and location modeling module cooperate to determine from the location data, time and speed of the user whether the user is ready to receive one of the user's tasks suitable for that area.

18. The server as described in claim 16, wherein the task and location modeling module receives a new task to be linked with the area as a response to a submission by the user to the task and location modeling module or inquiry by the task and location modeling module.

19. The server as described in claim 16, wherein the task and location modeling module calculates a rating for each task linked with an area.

20. The server as described in claim 19, wherein when the task and location modeling module cannot link the task with the area, or a rating for the area is lower than a predefined threshold value, the task location modeling module inquires the user about a possible current task.

21. The server as described in claim 16, wherein the planner is arranged for receiving task requirements and planning tasks.

22. A method, in a telecommunications network, for managing the activities of a user, the method utilizing a non-transitory computer-readable storage medium with an executable program stored thereon, the program instructing a microprocessor to perform the following steps:
receiving location data over time of the user at a region discovery module;
monitoring the speed of the user to detect an area where the speed is below a speed threshold;
recording successive user's locations at a task and location modeling module;
determining an area of the user at any given time from the location data with the region discovery module, by determining the area from the recorded locations where the user has a speed below the speed threshold; and
preparing a plan for the current time frame with a planner and submitting task information to the user for the current time frame with the task and location modeling module where a task is linked with the area, and inquiring the user with the task and location modeling module whether a new task is desired to be linked with the area where no task is linked with the area.

23. The method as described in claim 16, wherein the determining step includes the step of the region discovery module and the task and location module cooperating to determine from the location data, time and speed of the user whether the user is ready to receive one of the user's tasks suitable for that area.

24. The method as described in claim 22, wherein the determining step includes the step of the task and location modeling module receiving a new task to be linked with the area as a response to a submission by the user to the task and location modeling module or inquiry by the task and location modeling module.

25. The method as described in claim 22, including the step of receiving task requirements and planning tasks with a planner.
